(19) United States
(12) Patent Application Publication
(10) Pub. No.: US 2008/0007037 A1
(43) Pub. Date: Jan. 10, 2008

(54) Airbag module

(75) Inventor: Frank Sauer, Aschaffenburg (DE)

Correspondence Address: FOLEY AND LARDNER LLP;SUITE 500, 3000 K STREET NW, WASHINGTON, DC, 20007, US

(73) Assignee: Takata-Petri AG

(21) Appl. No.: 11/812,987

(22) Filed: Jun. 22, 2007

Related U.S. Application Data
(63) Continuation of application No. PCT/DE05/02290, filed on Dec. 14, 2005.

(30) Foreign Application Priority Data
Dec. 22, 2004 (DE) 20 2004 020 096.1

(51) Int. Cl. B60R 21/231; B60R 21/26

(52) U.S. Cl. 280/743.1

(57) ABSTRACT

An airbag module including a gas generator and an airbag. The gas generator and the airbag are arranged in the module housing one behind the other in the direction of a longitudinal axis of the airbag module so that the dimension of the airbag module is greater in the direction of the longitudinal axis than the dimension of the airbag module in a direction transversely to the longitudinal axis. The module housing is divided in the direction of the longitudinal axis of the airbag module and includes two housing shells. The airbag is connected to the module housing by a clamping frame which includes at least one gas conduction element.

The present application is a continuation of International Application No. PCT/DE2005/002290 which was published in German as WO 2006/066557.

### BACKGROUND

This application relates to an airbag module.

In addition to the airbags for the knee area (knee airbags) which are arranged in the lower part of the instrument panel, airbags for the passenger area (passenger airbags) are also provided in the instrument panel. Knee and passenger airbags typically have a high space requirement because of their bulky type of construction. These airbags have a large airbag deployment area. The passenger airbags, in particular, therefore require a considerable part of the surface of the instrument panel. One disadvantage of this arrangement is that the deployment area on the instrument panel lies in the head impact region of the occupant, which is not preferred for an occupant who is out of position. A further disadvantage of this arrangement of the passenger airbag is that the possibilities for the configuration of the instrument panel are restricted.

Locating the airbag in the roof region instead of the instrument panel is a possibility. However, since there is restricted space there in terms of height, it is known from U.S. Pat. No. 6,588,793 B2 to use a compressible module housing. In this airbag module, a tubular gas generator the tubular gas generator and approximately parallel to the vehicle roof. After the tubular gas generator and the airbag have been installed in the module housing, the latter is deformed such that the folded airbag is compressed and the height of the airbag module is only insignificantly greater than the diameter of the tubular gas generator.

This arrangement has the disadvantage, however, that, because of the small space available in terms of height, a considerable part of the airbag has to extend into the passenger space, since the airbag cannot be compressed to the extent desired. A further disadvantage is that, in the event of a crash, the lower part of the housing is pivoted in the direction of the occupant's head which is not preferred if the occupant is in an OOP sitting position.

Furthermore, DE 103 17 833 A1 discloses a passenger airbag with a disk-shaped gas generator installed on edge. Consequently, the dimensions of the module housing and therefore the required installation space behind the instrument panel of the vehicle are to be reduced. This arrangement has the disadvantage that the airbag module, although having a flat construction, still requires a large amount of space laterally, and therefore this airbag module has a large airbag deployment area.

EP 0 844 144 A1 discloses an airbag module in which a tubular gas generator and an airbag package are arranged one behind the other in the direction of the longitudinal axis of the airbag generator.

### SUMMARY

This application discloses an airbag module such that the airbag deployment area is reduced and a small installation space is required in the instrument panel, so that a passenger airbag module can be installed in the instrument panel even outside the head impact region.

In an exemplary embodiment of an airbag module, particularly for a passenger or knee area, with at least one gas generator and with at least one airbag in a module housing, the at least one gas generator and the at least one airbag are arranged in the module housing one behind the other in the direction of a longitudinal axis of the airbag module such that the dimension of the airbag module is greater in the direction of this longitudinal axis than transversely thereto, and the module housing is produced in two parts and, in particular, is divided in the direction of the longitudinal axis of the airbag module, so that it consists of two housing shells. This arrangement makes it possible to have a narrow, long airbag module with the smallest possible deployment area for the airbag. Since this deployment area is the area which is required for the airbag module on the instrument panel, this results in greater freedom in the configuration of future generations of instrument panels. Furthermore, beneficial mounting is achieved.

To achieve as small a module width as possible, it is provided in an exemplary embodiment, when disk-shaped gas generators are used, that at least one disk-shaped gas generator is arranged on edge in the modular housing, so that its space requirement is lower transversely to the longitudinal direction of the airbag module than in the direction of the longitudinal direction of the airbag module. In this case, there is the advantage that only the height of the disk-shaped gas generator determines the width of the airbag module. The radial outflow from the disk-shaped gas generator in the direction of the longitudinal axis of the airbag module allows an optimal inflow of the gas into the airbag and assists an efficient airbag deployment which nevertheless subjects the occupant to less load. Since the airbag runs from the narrow side of the gas generator and, in its folded position, approximately adheres to the width of this narrow side, that is to say in the direction of the longitudinal axis of the airbag module, the width of the airbag module is determined solely by the narrow side of the disk-shaped gas generator.

If tubular gas generators are used, to achieve a small module width, at least one tubular gas generator is arranged such that its longitudinal axis runs at least approximately in the direction of the longitudinal axis of the airbag module. Since the airbag and the tubular gas generator lie one behind the other in the direction of the longitudinal axis of the airbag module, the width of the airbag module is determined solely by the diameter of the tubular gas generator.

This airbag arrangement makes it possible that the airbag module can be arranged, as a passenger airbag module, in the vicinity of the windshield heel of the front windshield of a motor vehicle. An airbag module thus arranged then lies outside the endangered head impact region, and it extends essentially in the vertical direction, whereas it has only a low space requirement in the horizontal direction.

In order to ensure the leaktightness of the system, at least one seal is arranged between the housing parts in the mounted state. The seal provided may be, for example, a labyrinth seal and/or an adhesive seal and/or separate sealing rubbers.

The two housing parts may be connected to one another by means of connection methods known per se, such as, for example, screwing, snapping, gluing or welding by means of ultrasound.

In one embodiment, the airbag is connected to the module housing by means of a clamping frame. It is preferred that the clamping frame has at least one gas conduction element. The clamping frame can consequently at the same time assume the function of a diffuser.

The clamping frame may be connected to the module housing in various ways. In an exemplary embodiment, the clamping frame has straps which extend through the wall of the module housing and are fixed to the module housing outside the housing. Fixing may take place, for example, in that the straps are crimped outside the module housing or welded to the housing. By virtue of this type of fastening of the clamping frame, the frame may serve as a stiffening tie between the housing parts. Furthermore, there is the advantage that, because the module housing is divided in a longitudinal direction, the gas generator can be clamped between the housing shells and consequently be fastened in the module housing without further fastening means. In addition, using the clamping frame in this divided module housing, it becomes possible also to fasten the airbag in the module housing without additional fastening means.

Furthermore, it is also possible to fasten the airbag to the housing wall by the gas generators being slipped into the airbag mouth and subsequently clamped in the conventional way.

It is to be understood that both the foregoing general description and the following detailed description are exemplary and explanatory only and are not restrictive of the invention as claimed.

### BRIEF DESCRIPTION OF THE DRAWINGS

These and other features, aspects, and advantages will become apparent from the following description, appended claims, and the accompanying exemplary embodiments shown in the drawings, which are briefly described below.

FIG. 1 shows a passenger airbag module including a disk-shaped gas generator;

FIG. 2 shows a passenger airbag module including two disk-shaped gas generators;

FIG. 3 shows a passenger airbag module including a tubular gas generator;

FIG. 4 shows a section through a portion of a motor vehicle having an embodiment of the herein described passenger airbag installed.

### DETAILED DESCRIPTION

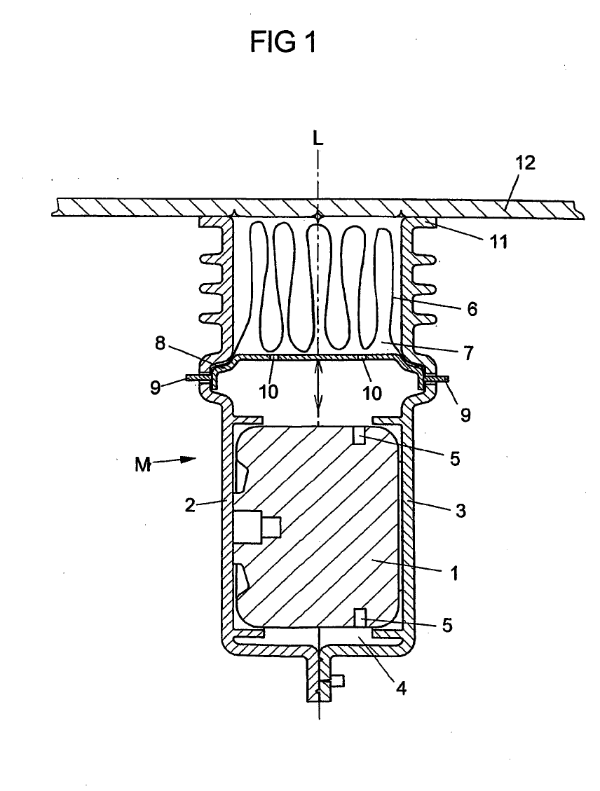

In the passenger airbag module M of FIG. 1, a disk-shaped gas generator 1, such as is customary for driver airbags, is arranged in a module housing which consists of two housing shells 2, 3 which extend in the direction of a longitudinal axis L over the entire length of the module housing and can, for example, be screwed to one another, with a seal, not illustrated, being interposed. The disk-shaped gas generator 1 is arranged on edge between these housing shells 2, 3 and, after the mounting of the module housing, is clamped between its housing shells 2, 3, so that additional fastening of the gas generator 1 is unnecessary. In the lower region, in which the housing shells follow (not illustrated) the round profile of the gas generator, there is a free space 4 between the gas generator 1 and the housing shells 2, 3, so that the gas emerging from gas outlet orifices 5 of the gas generator 1 can flow there into the module housing and can be deflected in the direction of an airbag 6. The airbag 6 is arranged above the gas generator 1 in the direction of the longitudinal axis L of the passenger airbag module. Said airbag extends there only in a width which corresponds approximately to the width of the gas generator. The airbag 6 is fixed in the region of its blow-in mouth 7 by means of a clamping frame 8 and the housing shells 2, 3. The clamping frame 8 has straps 9 which extend through the housing shells 2, 3. After the mounting of the housing, these can be crimped outside the housing shells 2, 3, so that the clamping frame 8 serves as a stiffening tie between the two housing shells 2, 3, and, moreover, the airbag is fastened between the clamping frame 8 and the housing shells 2, 3 without further fastening means. Furthermore, the clamping frame 8 serves as a diffuser in that orifices 10 are provided as gas conduction elements.

The passenger airbag module illustrated is connected in its upper region to an instrument panel 12 via a flange 11. It is clear that the gas generator 1 and the airbag 6 are arranged in the module housing one behind the other in the direction of the longitudinal axis L of the airbag module M such that the dimension of the airbag module M is greater in the direction of this longitudinal axis L than transversely thereto. It is clear, furthermore, that the deployment area for the airbag 6, which is determined in one direction by the height of the gas generator and in the second direction by the diameter of the gas generator, is small, as compared with modules of the prior art.

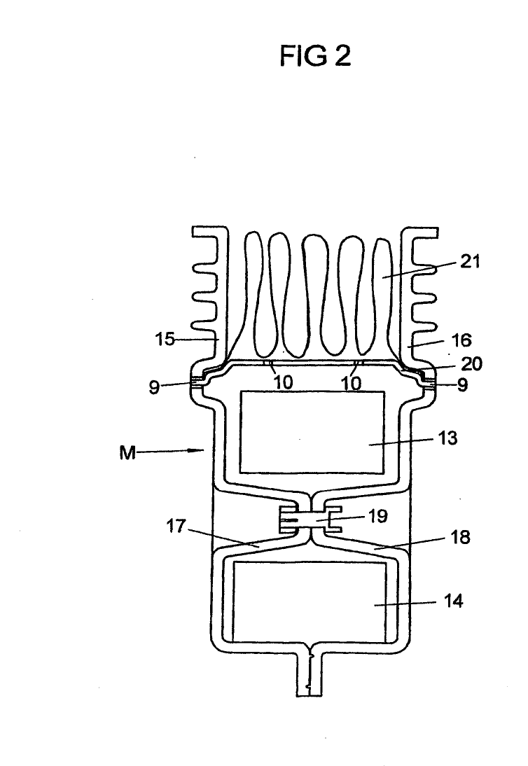

In the embodiment of FIG. 2, two disk-shaped gas generators 13, 14 are arranged one above the other in a module housing which is composed of two housing shells 15, 16. In addition to these screws, not illustrated, by means of which the housing shells 15, 16 can be screwed to one another at the edge, in this embodiment the housing shells 15, 16 are additionally connected by means of a screw connection 19 at turned-in portions 17, 18 which are provided between the gas generators 13, 14 on the housing shells 15, 16. In this embodiment, too, a clamping frame 20 is provided for fastening an airbag 21 in the region of its blow-in mouth.

Since, in this embodiment, too, the airbag lies above the two gas generators 13, 14 and, in the folded position, is only insignificantly wider than the diameter of the gas generators 13, 14, approximately the same advantages as in the embodiment of FIG. 1 arise.

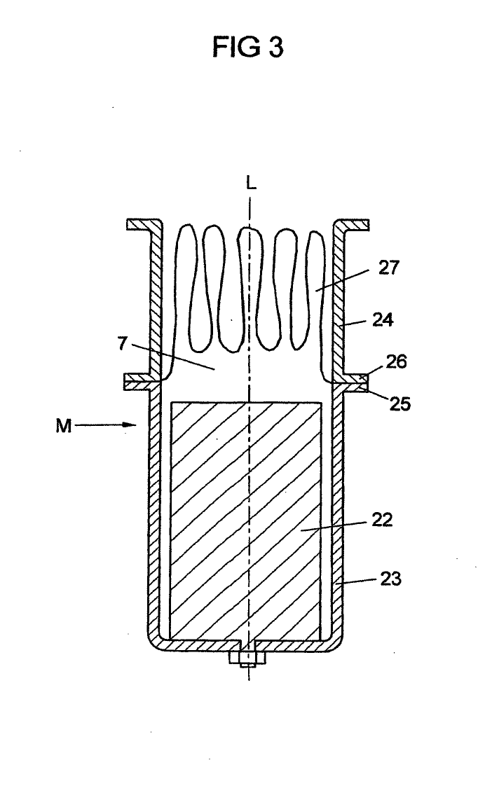

In FIG. 3, a tubular gas generator 22 is arranged in a module housing consisting of a lower housing part 23 and of an upper housing part 24 which can be connected to one another via flanges 25, 26. The tubular gas generator 22 is arranged in the lower housing part 23, the longitudinal axis of the tubular gas generator 22 running in the direction of the longitudinal axis L of the airbag module M. An airbag 27 is arranged in the upper housing part 24. Since the width of the folded airbag 27 is scarcely wider than the diameter of the tubular gas generator 22, this airbag module, too, has the advantages of the embodiments described above. In this embodiment, the airbag 27 is fastened in the region of its blow-in mouth 7 between the flanges 25 and 26.

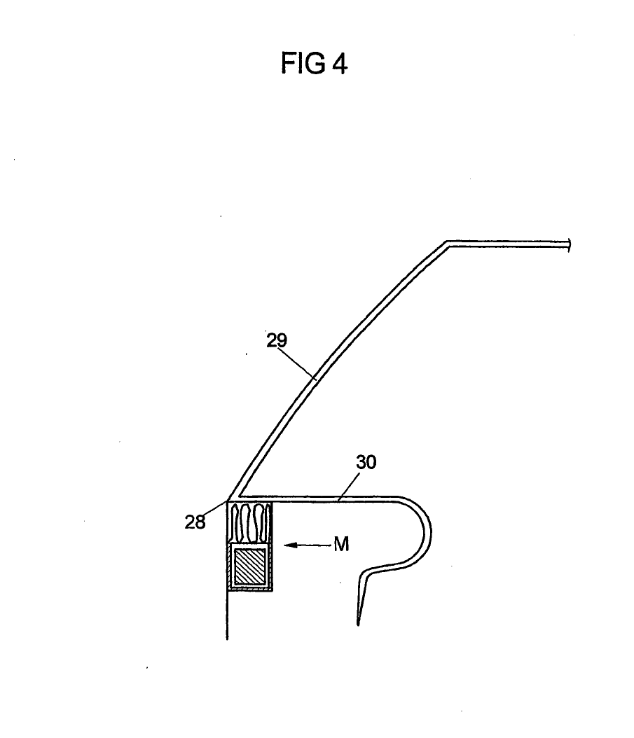

FIG. 4 illustrates how an airbag module may be arranged in the vicinity of the windshield heel 28 of a front windshield 29 of a vehicle. It is clear that the airbag module M is arranged below an instrument panel 30 in the region of the windshield heel 28, so that the airbag module lies outside the endangered head impact area.

What is claimed is:

1. An airbag module comprising:
a gas generator;
an airbag located in a module housing;
wherein the gas generator and the airbag are arranged in the module housing one behind the other in the direction of a longitudinal axis of the airbag module so that the dimension of the airbag module is greater in the direction of the longitudinal axis than the dimension of the airbag module in a direction transversely to the longitudinal axis;
wherein the module housing is divided in the direction of the longitudinal axis of the airbag module and includes two housing shells; and
wherein the airbag is connected to the module housing by a clamping frame which includes at least one gas conduction element.

2. The airbag module as claimed in claim 1, wherein the gas generator comprises a disk-shaped gas generator is arranged on an edge in the module housing, so that the dimensions of the space required to accommodate the gas generator in the housing are less in the direction transversely to the longitudinal axis of the airbag module than in the direction of the longitudinal axis of the airbag module.

3. The airbag module as claimed in claim 1, wherein the gas generator comprises a tubular gas generator arranged so that a longitudinal axis of the tubular gas generator extends in substantially the same direction as the longitudinal axis of the airbag module.

4. The airbag module of claim 1, wherein the airbag module is configured to be positioned in the vicinity of a windshield heel of a front windshield of a motor vehicle.

5. The airbag module of claim 1, wherein at least one seal is provided between the housing shells.

6. The airbag module of claim 1, wherein the clamping frame includes straps which extend through the wall of the module housing and are fixed to the module housing outside the housing.

7. The airbag module as claimed in claim 6, wherein the straps are crimped outside the module housing or are welded to the housing.

8. An airbag module including a gas generator and an airbag located in a housing that includes two housing shells, and wherein the gas generator and the airbag are positioned in sequence in the direction of a longitudinal axis of the airbag module so that the dimension of the airbag module is greater in the direction of the longitudinal axis than the dimension of the airbag module in a direction transverse to the longitudinal axis; and wherein the airbag is connected to the module housing by a clamping frame which includes at least one gas conduction element.
